(19) United States
(12) Patent Application Publication
(10) Pub. No.: US 2011/0080172 A1
(43) Pub. Date: Apr. 7, 2011

(54) TRANSMITTER SYSTEM, METHOD OF INDUCING A TRANSIENT ELECTROMAGNETIC FIELD IN AN EARTH FORMATION, METHOD OF OBTAINING A TRANSIENT ELECTROMAGNETIC RESPONSE SIGNAL, AND METHOD OF PRODUCING A HYDROCARBON FLUID

(76) Inventors: Eric Jan Banning-Geertsma, Milltimber (GB); Robert Rex Burnett, Katy, TX (US); Richard Martin Ostermeier, Houston, TX (US); Jeremiah Glen Pearce, Houston, TX (US); William Mountjoy Savage, Houston, TX (US)

(21) Appl. No.: 12/666,018

(22) PCT Filed: Jul. 1, 2008
(86) PCT No.: PCT/US08/68901

§ 371 Date: Dec. 15, 2010

Related U.S. Application Data
(60) Provisional application No. 60/947,823, filed on Jul. 3, 2007.

(51) Int. Cl. G01V 3/28

(52) U.S. Cl. 324/346

(57) ABSTRACT

A transmitter system for inducing a transient electromagnetic field in an earth formation comprises an inductive element to generate an electromagnetic field in response to a flow of electric current through the inductive element. Furthermore, switching means arranged to interrupt the flow of electric current through the inductive element, which switching means comprises a primary switch and an auxiliary switch arranged in series connection with each other. The auxiliary switch has a lower breakdown voltage than the primary switch. This induces a transient electromagnetic field in the earth formation. Delay circuitry may impose a time delay between switching of the auxiliary switch relative to switching of the primary switch. A transient electromagnetic response signal may be recorded, and used in a method of producing a mineral hydrocarbon fluid.

### FIELD OF THE INVENTION

The present invention relates to a transmitter system and a method for inducing a transient electromagnetic field in an earth formation.

In another aspect, the invention relates to a method of obtaining a transient electromagnetic response signal from an earth formation.

In still another aspect, the invention relates to a method of producing a mineral hydrocarbon fluid from an earth formation.

### BACKGROUND OF THE INVENTION

U.S. Pat. No. 7,053,622 discloses equipment and a method for mapping the geology in an underground formation, including a transmitter circuit with a current source for generating an electric current and a transmitter coil; a switch for connecting the current source to the transmitter coil during operation so that an electric current is generated in it, with the current building up a magnetic field in the formation, and for cutting off this current again so that the built-up magnetic field in the formation decays.

The current that needs to be cut-off can be high, for example 50 A or 70 A. US Pat. '622 proposes to use a metal-oxide-semiconductor field effect transistor (MOSFET), or an insulated gate bipolar transistor (IGBT), but recognizes a problem that none of the available switches satisfies all desired requirements, including sufficiently high break-down voltage, capability of switching sufficiently high currents, and having sufficiently low leakage current. Hence a choice has to be made regarding the balance of properties of the switch.

It is an object to provide a transmitter system and a method for inducing a transient electromagnetic field in an earth formation that does not need to be constrained to the choice as described, or is at least constrained to a lesser extent.

### SUMMARY OF THE INVENTION

In one aspect, the invention provides a transmitter system for inducing a transient electromagnetic field in an earth formation, comprising: an inductive element to generate an electromagnetic field in response to a flow of electric current through the inductive element; and switching means arranged to interrupt the flow of electric current through the inductive element, which switching means comprises a primary switch and an auxiliary switch arranged in series connection with each other.

In another aspect, the invention provides a method of inducing a transient electromagnetic field in an earth formation, comprising the steps of: providing, in a vicinity of the earth formation, inductive element to generate an electromagnetic field; allowing an electric current to flow from a power supply through a primary switch, an auxiliary switch, and the inductive element; and terminating the electric current from flowing through the inductive element by opening the primary switch and opening the auxiliary switch.

In still another aspect, the invention provides a method of obtaining a transient electromagnetic response signal from an earth formation, comprising the steps of: bringing a receiver antenna in the earth formation; bringing, in the earth formation, a transmitter antenna comprising an inductive element to generate an electromagnetic field; allowing an electric current to flow from a power supply through a primary switch, an auxiliary switch, and the inductive element; terminating the electric current from flowing through the inductive element by opening the primary switch and opening the auxiliary switch; and receiving a transient response signal following the terminating of the electric current, employing the receiver antenna.

In yet another aspect, the invention provides a method of producing a mineral hydrocarbon fluid from an earth formation, the method comprising steps of: drilling a well bore in the earth formation; providing, in the well bore, an inductive element to generate an electromagnetic field; allowing an electric current to flow from a power supply through a primary switch, an auxiliary switch, and the inductive element; terminating the electric current from flowing through the inductive element by opening the primary switch and opening the auxiliary switch; receiving a transient response signal following the terminating of the electric current; further processing the transient response signal to locate the mineral hydrocarbon fluid in the earth formation; continuing drilling the well bore to the hydrocarbon fluid; and producing the hydrocarbon fluid.

A geosteering cue may be derived from the further processing, whereby the continued drilling may be responsive to the geosteering cue.

### BRIEF DESCRIPTION OF THE DRAWINGS

The present invention is described in more detail below by way of examples and with reference to the attached drawing figures, wherein:

FIG. 1A schematically shows a coil connected to a power supply and a snubber circuit;

FIG. 1B schematically shows an electrical equivalent circuit corresponding to FIG. 1A;

FIG. 2 shows a graph of calculated voltage V_{c}(t) across the coil in FIG. 1A as a function of time t following switching;

FIG. 3 schematically shows the coil system of FIG. 1A provided with a switching means comprising a primary switch and an auxiliary switch;

FIG. 4 schematically shows an embodiment of the switching means employed in FIG. 3;

FIG. 5 schematically shows another embodiment of the coil system of FIG. 1A provided with a switching means comprising a primary switch and an auxiliary switch;

FIG. 6 schematically shows an embodiment employing an opto-coupler;

FIG. 7 schematically shows a drilling system;

FIG. 8 schematically shows a segmented transmitter system connected to a power supply;

FIG. 9 schematically shows a view of helically wound groups of coil windings;

FIG. 10 schematically shows a model of a transmitter system comprising 5 groups of coil windings;

FIG. 11 schematically shows a transmitter system representative of a class of other embodiments;

FIG. 12 schematically shows a transmitter system representative of another class of other embodiments;

FIG. 13 schematically shows a transmitter system representative of still another class of other embodiments; and

FIG. 14 shows an alternative snubber circuit employing a Zener diode.

### DETAILED DESCRIPTION OF THE INVENTION

A transmitter system is disclosed, for inducing a transient electromagnetic field in an earth formation. Such a transmitter may be incorporated and/or used in a tool and/or method for transient electromagnetic (EM) logging, which provides information on electromagnetic properties of a formation around the tool at various distances from the tool. In this transient EM method, a transmitter antenna is energized which energizing is generally terminated after which a temporal change of signal (e.g. voltage) induced in a receiver antenna is monitored over time.

The transmitter and receiver antennae may typically be provided in the form of coils as described in, for instance, US patent application publications 2005/0092487, 2005/0093546, and 2005/078481, and in U.S. Pat. No. 5,955,884, each incorporated herein by reference. On the transmitter end, such a coil represents an inductive element and thus it forms an inductive load.

It is now proposed to interrupt the flow of electric current through an inductive element using switching means that comprise a primary switch and an auxiliary switch arranged in series connection with each other, and delay circuitry to impose a time delay between switching of the auxiliary switch relative to switching of the primary switch.

Provision of a primary and an auxiliary switch provides more versatility in designing the switching means to fulfill desired requirements. It allows for combining favorable properties of the primary switch with other favorable properties of the auxiliary switch. The favorable properties of the auxiliary switch may be complementary to those of the primary switch, for instance to compensate for a less favorable property of the primary switch, which allows an ability of disregarding that property when selecting the type of primary switch to employ.

As an example, this concept may be applied in the following situation. When the flow of current through such an induction coil is rapidly turned off or terminated, a voltage spike is built across the coil due to back-electromagnetic force (back-EMF or counter-EMF) effects. This voltage spike may exceed maximum tolerances of one or more of the components in the tool. In such a case, the switching means may comprise a primary switch with a high break-down voltage, optionally combined with an ability to cut-off a high current. Any adverse property of such a primary switch, such as possibly a high leakage current or tailing current, may be compensated by selecting the auxiliary switch to provide that function.

Delay circuitry may be provided to impose a time delay between switching of the auxiliary switch relative to switching of the primary switch. Opening the auxiliary switch after opening the main switch, helps to ensure that the auxiliary switch is not exposed to any adverse back-EMF voltage. Since the primary switch may have already dealt with the voltage spike and/or the cutting off of a high current, the auxiliary switch does not have to possess such capabilities.

The primary switch may, as a result, be selected due to its favorable breakdown properties (e.g. high breakdown voltage) without also considering all the other relevant properties such as low leakage current, because the auxiliary switch may be selected on the basis of other properties such as a low leakage current. If such other property will be contributed to the switching means by the auxiliary switch, the primary switch does not have to have a favorable leakage current.

Stated more generally, if at least two specified electrical characteristics are of interest, the switching means could be favorable in respect of both these characteristics whereby one of the electrical characteristics of the switching means is attributable to a corresponding electrical characteristic of the primary switch and the other one is attributable to a corresponding characteristic in the auxiliary switch.

In logging while drilling (LWD) applications, it is advantageous to detect the presence of a formation anomaly ahead of a drill bit or around a bottom hole assembly.

U.S. patent application published under number 2006/0038571 describes methods for localizing an electromagnetic anomaly in a subterranean earth formation, employing transient electromagnetic methods. These methods particularly enable finding direction and distance from a transient electromagnetic measurement tool to a resistive or conductive anomaly in a formation surrounding a borehole in drilling applications.

In these methods, typically a tool, comprising a transmitter coil and a receiver coil, is lowered into a borehole in the earth formation. The transmitter coil produces a magnetic dipole field in the formation. Due to, for instance geometric properties of the transmitter system, in practice the dipole field will be an approximate dipole field. A transient response signal, comprising an induced voltage in the receiver coil, is measured after rapidly turning off the current that is passed through the transmitter antenna. The sudden drop is understood to generate decaying eddy currents in the formation, which in turn induce the transient response signal at the receiver antenna.

The referenced US patent application shows that relevant conductivity information of the earth formation is embodied in the response signals over the entire time span of the decay, starting already during the first microseconds after the sudden drop in the current and continuing up to perhaps even seconds.

The coils may be wound coaxially around a longitudinal axis of a down-hole tool, or they may be provided in another way. Examples include winding at an angle relative to the longitudinal axis of the down-hole tool, or winding according to a so-called saddle coil configuration whereby the windings of the coil do not fully encircle the longitudinal axis of the down-hole tool. Energizing of the transmitter antenna may be accomplished by applying a current through a transmitter coil. The current applied at a transmitter antenna is generally terminated to terminate the energizing.

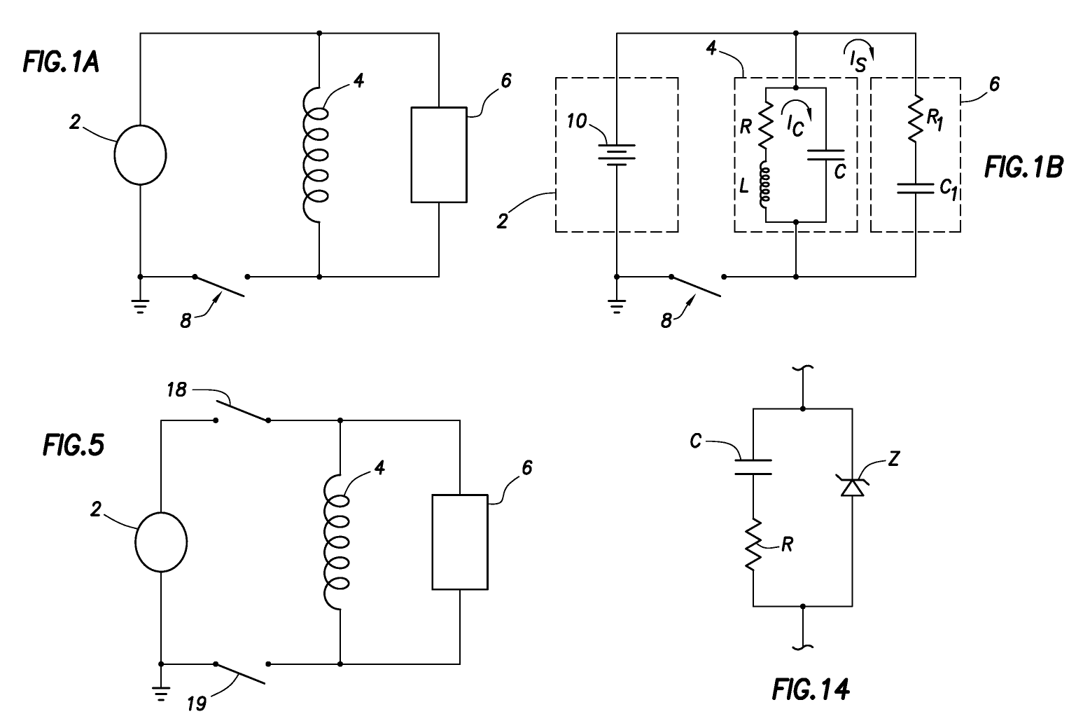

FIGS. 1A and 1B schematically show a transmitter system that may be incorporated in a down-hole tool. FIG. 1A schematically shows a transmitter antenna in the form of coil 4 connected to a power supply 2 via a switch 8. An optional shunt in the form of snubber circuit 6 is connected parallel to the coil 4.

FIG. 1B shows a possible equivalent electric circuit of the comparative example. A physical coil 4, typically not only provides an inductance L but also a non-zero resistance R and a distributed capacity C as shown in FIG. 1B. These properties may give rise to a resonance current in the coil, I_{c}, also indicated in FIG. 1B.

The optional snubber circuit 6 has been assumed to comprise a resistor R₁ and a series capacitor C₁, tuned to prevent the current from oscillating as well as to control the current decay I_{c}(t) within the coil 4. It could, however, include more and/or other components, as will be exemplified below, or the snubber circuit 6 could consist of a damping resistor only.

The power source 2 has been assumed to comprise of a DC voltage source 10. For the purpose of the present specification, a DC voltage may include relatively slowly varying voltage waveforms compared to the desired measurement interval, or AC waveforms with a non-zero DC offset component that is large relative to the AC component. Slowly varying is understood to include frequencies of up to a few Hz, typically up to about 5 or 10 Hz, depending on the desired measurement interval. Preferably, the DC current is very constant and steady for at least 10 ms prior to turn-off.

The DC voltage source 10 may be a bipolar source switched such that the polarity of the voltage imposed over the transmitter coil is reversed in each subsequent energizing cycle.

The switch 8 will be assumed to comprise of an ideal switch capable of switching between true zero impedance and infinite impedance states instantaneously.

When the switch has been closed (its zero impedance or zero-resistance state) for a sufficiently long time, a DC current I corresponding to I=V/R passes through the coil 4 causing a static magnetic field. Prior to opening switch 8, the inductor L acts as a short due to the DC character of the current. The voltage across the coils, V_{c}, is therefore equal to the voltage V of the source 10.

Opening switch 8, resulting in an instantaneous increase in its resistance from essentially zero to essentially infinite provided that the voltage across it does not exceed a break-down limit, would collapse the static magnetic field. Faraday's law states that a changing magnetic field results in an electromotive force (EMF, ξ) that is equal to the time-derivative (d/dt) of the magnetic flux.

Since part of the flux associated with the magnetic field passes through the coil 4, switching it off causes a back EMF. A back EMF that is too large may cause a problem on for instance the switch 8.

The total voltage across the coil 4 is given by the sum of the back-EMF plus R·I(t). In an induction coil, the back-EMF may be expressed as its self-inductance L times the time-derivative dI_{c}/dt of the current I_{c}(t). Thus, after opening the switch 8, the EMF is likely to become the dominant term. Since current I_{c}(t) is decaying, the voltage across the inductive load L will have a reverse polarity relative to that across the resistor R.

As an example, Table I summarizes parameters of a transmitter coil as it might be employed in a down-hole transient EM tool.

TABLE I

| Parameter | Symbol | value | |
|---|---|---|---|
| Coil diameter | | 14 | cm |
| Number of windings | N | 125 | |
| Pitch of windings | | 2 | mm |
| Axial length of coil | l | 25 | cm |
| Self-inductance of coil | L | 0.95 | mH |
| Ohmic resistance of coil | R | 0.46 | Ω |
| Distributed Capacitance coil | C | 50 | pF |
| Snubber Resistance | R₁ | 2100 | Ω |
| Snubber Capacitance | C₁ | 1 | μF |

Self-inductance has been derived from the dimensions using a formula in W. R. Smythe “Static and Dynamic Electricity”, third edition, Hemisphere, New York, 1989. The ohmic resistance has been calculated assuming the coil has been formed out of 14 gauge copper wire and assuming room temperature. The capacitance of the coil is based on an estimate.

The snubber resistance and capacitance have been chosen to achieve a −80 dB attenuation of the current at 3 μs after opening the switch 8.

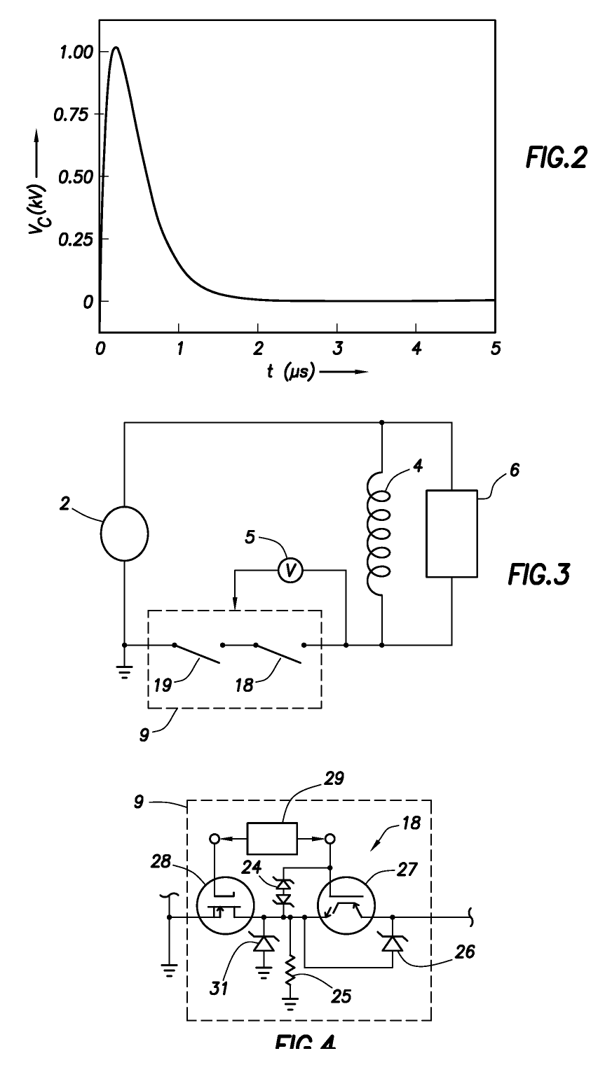

The current I_{c}(t) and the voltage in the coil 4 and the resulting back EMF voltage V_{c}(t) across the coil may be calculated using the equivalent electric circuit as depicted in FIG. 1B. The voltage across the coil, V_{c}(t), resulting in turning a DC current of 6.5 A off by a factor of −80 dB in less than 3 us is shown in FIG. 2. It reveals that switching at that rate results in a voltage spike of about 1 kV, which is generally too much for a typical metal-oxide-semiconductor field-effect transistor (MOSFET), but still below break down voltage of some commercially available insulated gate bipolar transistors (IGBTs). Insulated gate bipolar transistors, known in the art as IGBT may realistically have switching speeds of less than 1 μs, and relatively high breakdown voltage exceeding 1 kV.

A switch that has a high break-down voltage allows relatively high turn-off rates of the current through the transmission coil, because back EMF scales with the time derivative of the current (dI/dt) or the self-inductance L, or both. However, the fast, high break-down voltage switches that are presently commercially available, e.g. IGBTs, typically have been found to suffer from a fairly high trailing current that may persist

It has been found that an IGBT with a relatively fast initial turn-off time and a high break-down voltage, which as explained above is useful when dealing with a relatively high back-EMF voltage, may also suffer from a tailing current that may persist up to hundreds of microseconds after the initial turn-off Such a tailing current may be relatively small compared to the initial current, but it may still adversely affect the signal to noise ratio of a transient electromagnetic logging tool since the transient response signals from the earth formation after a few hundred microseconds is also expected to be very small.

The turn-off may be expedited and the signal-to-noise ratio increased by providing, instead of a single switch 8, a switching means 9 to provide improved switching functionality. The switching means 9, as shown in FIG. 3, comprises a primary switch 18 and an auxiliary switch 19 arranged in series connection with each other. The fact that there is a plurality of switches comprised in the switching means allows, for instance, the primary switch 18 to be selected on the basis of its favorable breakdown properties (e.g. high breakdown voltage), and the auxiliary switch 19 to be selected on the basis of other properties such as switching time and/or leakage current and/or tailing current.

The example shown in FIG. 3 shows the switching means 9 in series with power supply 2 and coil 4 shunted with optional snubber 6, basically corresponding to what was modeled hereinabove with reference to FIGS. 1A/B and 2.

In order to protect the auxiliary switch from exposure to excess voltage exceeding its break-down voltage during turning-off, the auxiliary switch may be kept into its low-impedance (resistance) state for a duration of time after bringing the primary switch 18 into its high-impedance state before the auxiliary switch is brought into its high-impedance (resistance) state. In other words, a certain delay time may be applied for switching the auxiliary switch, which may in practice be implemented by providing delay circuitry of any suitable type.

There are numerous ways to implement delay circuitry, including using a digital signal processor (DSP) with a timer or a clock and any suitable type of controller or micro-controller such as a programmable interface controller (PIC).

FIG. 4 shows an embodiment of the switching means 9, wherein the primary and auxiliary switching means are provided in the form of gate transistors. A common gate transistor is a field-effect transistor (FET). A gate transistor may have a first and second terminals connected with each other via a gated channel. These terminals may be referred to with various terms, of which source and drain, collector and emitter, etc., are examples. The switching occurs between these terminals as a result of impedance changes in the gated channel, depending usually on gate potential relative to one of the first and second terminals (usually the drain or the emitter). A gate terminal is provided to regulate the gate voltage.

In FIG. 4, the primary switch 18 is provided in the form of an IGBT 27, and auxiliary switch 19 is provided the form of a MOSFET 28. The auxiliary switch 19 may be used to shut off the tailing current from the IGBT 27. As a result, the residual field generated by the coil is suppressed leading to an improved signal-to-noise ratio.

Delay circuitry 29 is provided and arranged to delay the switching of the auxiliary switch 19 relative to the switching of the primary switch 18. For instance, the primary switch 18 may be coupled to a primary switch controller for controlling the switching of the primary switch, and the auxiliary switch 19 may be coupled to an auxiliary switch controller for controlling the switching of the auxiliary switch, wherein the auxiliary switch controller may be coupled to the delay circuit 29.

The delay time may be selected to be long enough for any back-EMF voltage to fall to a level below a predetermined value. The predetermined value may be selected such that there is no danger of exceeding the break-down voltage of the auxiliary switch. In the configuration as shown in FIGS. 3 and 4 jointly, the auxiliary switch will in principle not be exposed to any back EMF after the primary switch is in its high-impedance state. In such a case, the delay could be as close to 0 as the transition time associated with the primary switch switching from closed to open.

In other configurations, when at least one of the poles of the auxiliary switch could be exposed to the back-EMF voltage generated in the coil, e.g. as shown in FIG. 2, the required delay time may be found by finding the time that it takes for the voltage to drop below the break-down voltage of the auxiliary switch. If that is 200 V, as may be quite typical for a MOSFET, the delay time may for instance be chosen at 1.0 μs or longer.

More generally, if the breakdown voltage for a specific switch would be V_{b}, a minimum delay time may be found in the voltage V_{c}(t) behavior after switching the primary switch to its high impedance state by finding the time t_{delay} after switching of the primary switch at which the back-EMF voltage induced in the coil across the auxiliary switch has decayed to below V_{b}.

Feedback and control means 5 may be provided, arranged to control the switching of the auxiliary switch in response to a signal representing actual back-EMF voltage generated in the inductive element as a function of time, at times after switching of the primary switch. For instance, a signal representing the voltage V_{c}(t) of FIG. 2 could be used as the feedback signal in order to generate a trigger signal or a gate signal that triggers or results in the switching of the auxiliary switch.

The delay time may thus be made dependent on the decay of the back-EMF voltage. Alternatively, the delay time may be predetermined, for instance such as to achieve a desired target turn-off time. When a certain attenuation of current is desired in a certain time, the delay time may be chosen at the desired time minus the specified switching time of the auxiliary switch. For example, when a −80 dB attenuation in 3 μs is desired, the delay time may be predetermined at anywhere between 0.1 μs and 3 μs, or for more typical back-EMF voltage spikes, between 1 μs and 3 μs.

FIG. 4 also shows optional protection shunts comprising Zener diodes 26 and 31. Zener diode 26 directly connects the emitter of IGBT 27 to its collector and Zener diode 31 connects the source to the drain of MOSFET 28. More generally, the diodes are connected in parallel to the primary and/or auxiliary switches and schematically represent optional protection circuits, which protect the switches against excess voltage exceeding their break-down voltage. In reality, a number of Zener diodes, or other non-linear components, may be used in series depending on the break-down voltage of the individual Zener diodes.

More generally, the protection circuit shunts may comprise an active element, for example a diode, a varistor, a Zener diode or an avalanche diode. The principle of operation is that the switch is bypassed by a path which has an effective impedance that decreases with potential difference. Such a non-linear component ensures that the switch is protected against an excess voltage. A number of such active elements may be connected in series in order to divide the voltage drop over the number of elements. Oscillations may not be an issue in the switches, in which case the protection circuit may consist of only the active element(s). Some gated transistors have such a protection shunt built-in, in which case an additional protection shunt may be redundant.

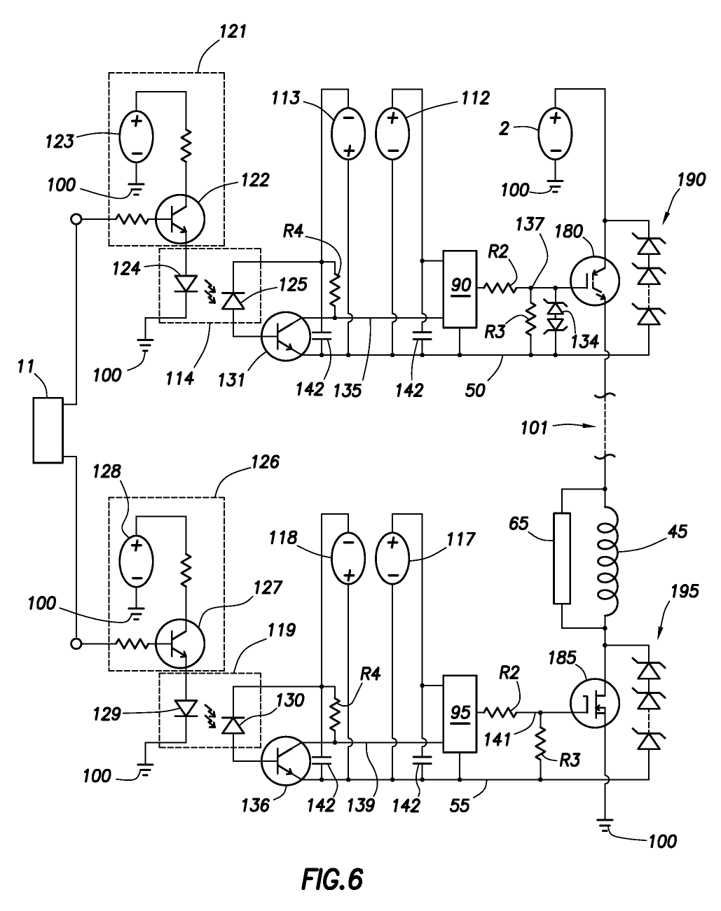

Resistor 25 in FIG. 4 may be provided to keep the emitter of the IBGT close to ground, to ensure that the gate voltage can be set relative to ground. However, there are other ways of referencing the gate voltage. An example will be given below with reference to FIG. 6.

Also shown in FIG. 4 is a potential limiting circuit 24, arranged to limit a potential difference between the gate terminal and the emitter terminal In the present case, the gate-emitter potential determines whether the switch is open or closed. The potential limiting circuit 24 protects the switch against a to high potential difference, which could burn out the switch.

Here, the potential limiting circuit 24 is provided in the form of two Zener diodes arranged back-to-back such that they are blocking conduction between gate and emitter terminals. However the potential difference is limited to the Zener break down voltage. For this application, the Zener break down voltage is typically less than 20 V, for instance between 5 V and 15 V. We used 12 V Zener diodes as they are cheap and effective. However, other active components may be used, such as avalanche diodes, or other potential limiting circuits 24 that may be devised by a person of skill in the art.

The primary and auxiliary switches do not have to be in direct connection with each other such as is the case in the embodiment of FIG. 3. For instance, as schematically depicted in FIG. 5, the auxiliary switch may be series connected between the inductive element (e.g. coil 4) and one pole of the power supply 2, while the primary switch may be series connected to the other side of the inductive element and the other pole of the power supply 2. Either one of the poles of the power supply 2 may be connected to ground.

In embodiments such as described above with reference to FIG. 5, the inductive element has a switch on either side and can thus be cut-off entirely from other elements or circuitry, which may lower even further the chance of a residual magnetic field to be generated after turning-off. However, the primary switch 18 is not commonly grounded to the ground to which power supply 2 is grounded. If the primary switch is based on a gated transistor, such as an IGBT, this may have to be taken into account when referencing a gate voltage.

The upper switches (upper switches are those that do not reference to the common ground) may have to be referenced to a separate ground from the main power supply 2. An example of how this may be done employing gated transistor switches 180 and 185, each comprising a gate, an emitter and a collector, is schematically depicted in FIG. 6.

FIG. 6 shows a group of coil windings 45, which may correspond e.g. to the coil 4 of FIG. 5, that is connected to the common ground 100 via switch 185, hereinafter referred to as the lower switch 185. FIG. 6 also shows the switch 180 that is connected to the main power supply 2. This will be referred to as the upper switch 180. For the purpose of the present example, upper switch 180 will be assumed to function as the primary switch of the switching means and lower switch 185 will be assumed to function as the auxiliary switch. Consistently, upper switch 180 has been depicted as an IGBT while lower switch 185 has been depicted as a MOSFET, but the principle as will be set forth below does not require these specific types of switches. Moreover, the assignment of primary and auxiliary switching function is arbitrary chosen by way of example, and the roles may be interchanged.

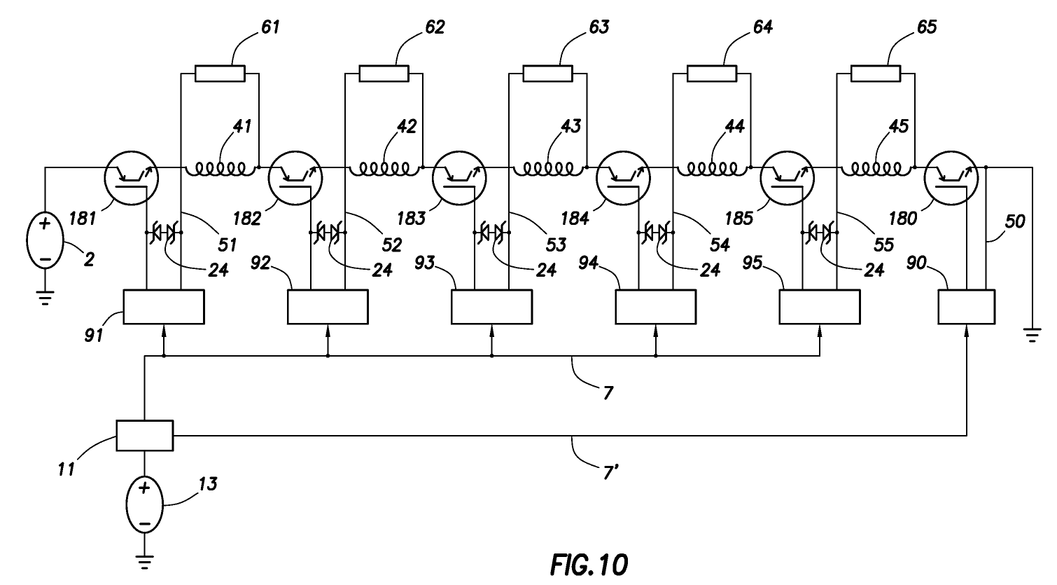

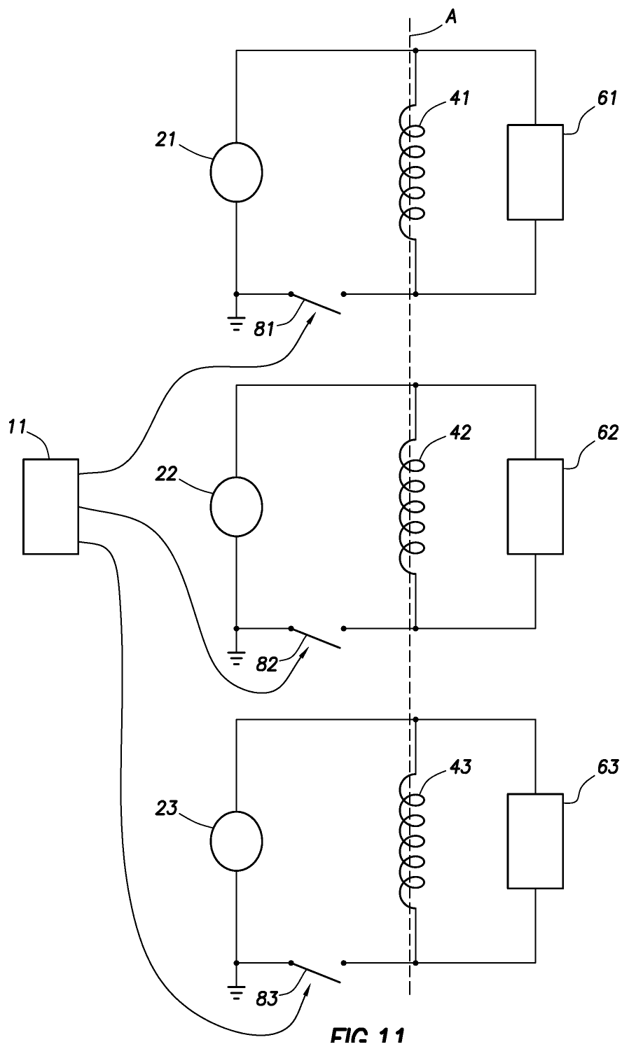

The group of coil windings 45, which will also be referred to as coil segment 45, may constitute a full coil, or it may be one group amongst any number of additional groups of coil windings. In the latter case, which will be illustrated in more detail hereinbelow with reference to FIG. 10, additional switches may be provided between the present coil segment 45 and upper switch 180, as schematically indicated at 101 in FIG. 6.

The principles that will be set forth also apply for switch 180 if there would be another coil segment provided between switch 180 and the main power supply 2, such as is the case for instance with respect to switch 181 in FIG. 10 to be discussed herein below.

An optional snubber circuit 65 is depicted connected in parallel with the coil segment 45. Optional switch protection circuits 190 and 195 have been depicted connecting emitter and collector of switches 180 and 185, respectively. More details have been provided hereinabove.

Still referring to FIG. 6, the gate voltage of the lower switch 185 is referenced to the potential in line 55, which is connected to the common ground 100. The electronics driving the gate of upper switch 180, including power supplies 112, 113 and gate driver 90 are referenced to the potential in line 50 which is connected to the emitter of the upper switch 180 and acts as a “floating ground” as soon as the lower switch 185 is open. As a result, the gate voltage of upper switch 180 is referenced to the emitter of upper switch 180.

The potential of the “floating ground” relative to the common ground could be quite high, and variable, as a result of back-EMF induced by the coil segments, when the switches are opened. The embodiment of FIG. 6 provides an opto-coupler 114, to electrically isolate other controller electronics (including, e.g., microcontroller 11 of FIG. 10) from the floating ground. Such an opto-coupler is also shown at 119 for the lower switch, as an option.

An opto-controller essentially comprises a controllable light source, here shown in the form of a light emitting diode (LED) 124, 129, in optical communication with a light detector, where shown in the form of a photo-diode 125, 130. The LED and photo diode may be in each other's near vicinity, such as integrated on the same circuit board or micro-electronic chip, or at remote distances with a light-conducting medium between them such as an optical fiber, or in any other configuration. A suitable integrated opto-coupler is available as part number PS8601.

If the microcontroller 11 cannot source enough current to drive the opto-controllers, an intermediate switch 121, 126 may be provided in between. Such intermediate switch may be provided in the form of a relay, an amplifier, a switching transistor or other suitable arrangement. Here, as an example, the intermediate switch is provided in the form of a switching transistor 122, 127, the base thereof being connected to the microcontroller 11 output, via for instance a resistor, and an amplifier power supply 123, 128. The amplifier power supplies may be provided in the form of one power supply supplying the power for all or a plurality of the amplifiers 121, 126. This way, light generation in the LEDs 124, 129 may be activated using the microcontroller 11.

The photo diodes 125, 130 are arranged to activate another intermediate switch, here provided in the form of a second switching transistor 131, 136 arranged to be biased by the photo diode 125, 130 in combination with a power supply 113, 118. Lines 135 and 139 connect the second switching transistor 131, 136 to their respective gate driver 90 and 95, which are powered by power supplies 112 and 117, respectively. The gate drivers 90, 95 put the gates of switches 180 and 185 on a controlled voltage referenced to lines 50, 55. A resistor R₄ may be provided between each of lines 135 and 139 and their respective power supply 113 and 118.

An optional voltage divider, e.g. consisting of two resistors R₂ and R₃, may also be provided between the gate driver 90, 95 the switches 180, 185 and the floating grounds 50, 55 if needed, e.g. to enhance stabilization. Typically, one might choose R₃>>R₂, e.g. R₃ is a few kΩ and R₂ a few Ω.

Also, a potential limiting circuit 134 may be provided to ensure that the potential difference between the gate terminal 137 and the emitter terminal of the IGBT 180 stays within a window set by the circuit.

In operation, a low pulse from the microcontroller causes the transistor 122, 127 to switch on and activate light generation in the LED 124, 129. The collector of the second switching transistor 131, 136 thus goes high for the duration of the initial low pulse from the microcontroller 11, turning the respective gate 137, 141 of the IGBT 180, 185 on for the duration of the in initial low pulse. This brings the switches into their low-impedance condition and the coil segment 45 is energized at a level determined by the current delivered by the main power supply 2.

The outputs of the microcontroller 11 are then brought to high, turning the IGBTs off and thereby creating the transient electromagnetic field. A transient response signal may be recorded at this time. The microcontroller 11 could be programmed such as to bring the high output on the line leading to the switch that functions as the auxiliary switch (here: switch 185) at a later time than when the high output was brought on the line leading to the switch that functions as primary switch (here: switch 180).

The operation may be repeated over and over again for as long as desired.

Optional capacitors 142 may be provided through-out, to bleed off any AC components from the circuitry to the floating ground. Their capacitance values would be easy to determine based on the specific characteristics of an embodiment.

A transmitter system in accordance with the principles set forth above, may be employed to obtain a transient electromagnetic response signal from an earth formation. Such a response signal may be sensed after terminating the current, by a receiver antenna that is brought into the earth formation, for instance via a bore hole or a well bore. The use of the delayed auxiliary switch as set forth above is applicable to switching of induction elements including coils.

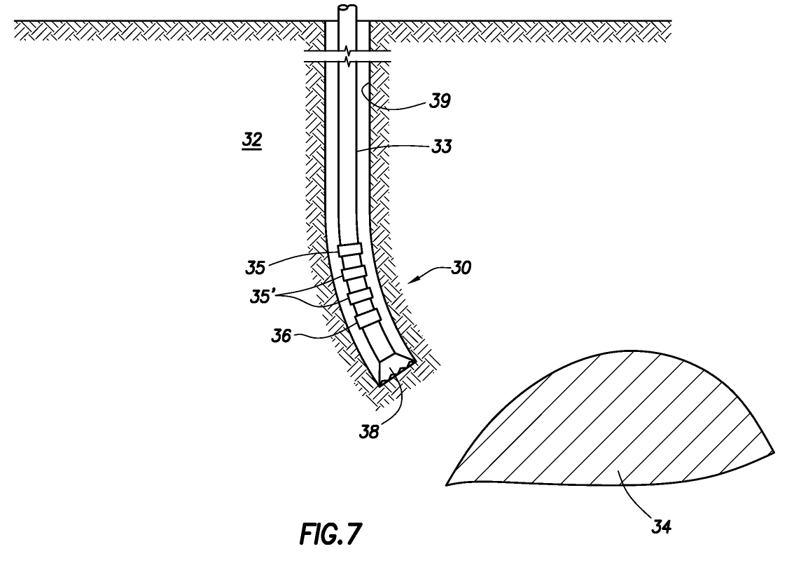

FIG. 7 shows a down-hole tool 30 for such transient electromagnetic induction measurements of an earth formation 32. The down-hole tool is adapted to fit inside a typical bore-hole in an earth formation. In the embodiment as shown, the down-hole tool 30 is incorporated in a drill string 33 supporting a drill bit 38 in a bore-hole 39. A reservoir containing a mineral hydrocarbon fluid 34 is also present.

The down-hole tool 30 may typically be included in a bottom hole assembly (BHA) as part of a logging while drilling (LWD) tool and/or of a measurement while drilling (MWD) tool. The tool may be used in logging and/or measurement while drilling applications, including geo-steering, reservoir delineation and geo-pressure detection.

In other embodiments, the down-hole tool may be suspended in the bore-hole 39 on a wire line. Wire line tools as such are known: one is shown and described in U.S. Pat. No. 6,952,101, of which the contents are herein incorporated by reference.

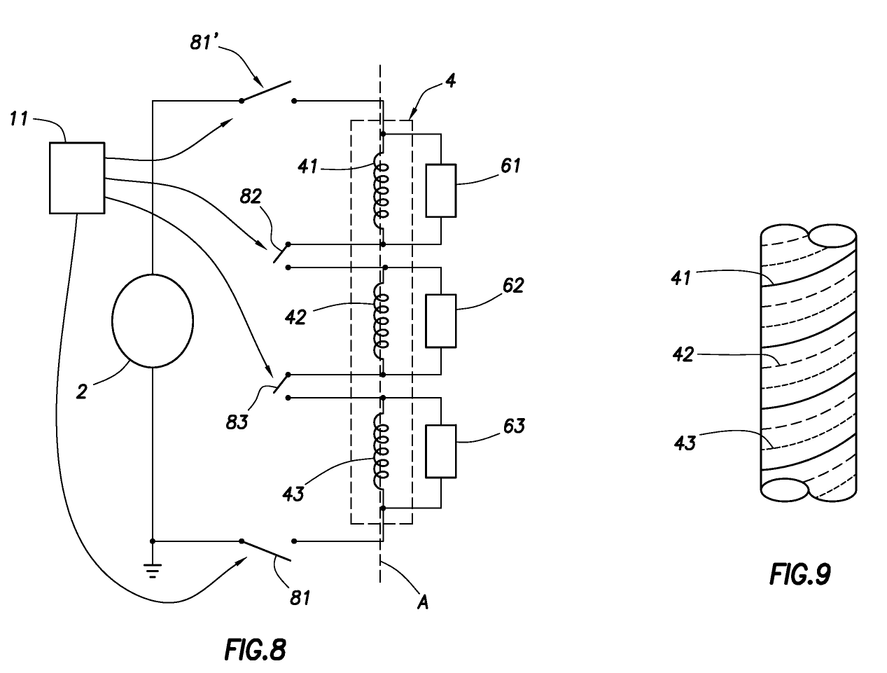

The down-hole tool 30 as depicted in present FIG. 7 comprises a transmitter system comprising transmitter antenna 35 and a sensor in the form of a receiver antenna 36 displaced from the transmitter antenna 35 at a predetermined offset. A predetermined offset, however, is not a requirement of the invention. The transmitter antenna may comprise a coil with a number of windings to generate essentially a magnetic dipole field. The number of number of windings is optionally divided into two or more groups of windings 35, 35′, arranged to cooperatively generate the essentially magnetic dipole field when energized. Further details on dividing the windings into groups of windings will now be provided, with reference to FIGS. 8 to 13. The coils may be solenoid coils and, likewise, the groups of windings may also be solenoidal of nature.

It has been estimated that, detecting a resistivity anomaly up to 50 to 100 m away from the tool out in the formation using a transmitter coil and a receiver coil as the antennae, a magnetic moment of 50 A·m² in the transmitter coil and an effective area of 100 m² in the receiver coil would be sufficient. For the purpose of down-hole investigations, a magnetic moment of between 1 A·m² and 1000 A·m² has found to be generally practicable.

Moreover, for detecting the anomaly close by the tool, a turn-off time of 3 μs may be desired to be able to measure its electromagnetic properties without contribution from the transmitter coil still generating a field.

The magnetic moment, m, of a coil is given by:

m=N·s·I (1)

wherein N is the number of windings in the coil, s is the cross-sectional area of the air-core defined by the windings, and I the current passed though the coil.

To generate a magnetic moment of 50 A·m² using the coil as summarized in Table I above, a DC current of 26 A must be passed through it.

As stated before, back-EMF scales with the time derivative of the current (dI/dt) or the self-inductance L, or both. Thus, switching 26 A instead of the 6.5 A in the same time as was used for calculating FIG. 2, the back-EMF would exceed the approximately 1 kV of FIG. 2, which could pose a problem for the switching means used. At first glance, instead of increasing the current one could consider increasing N or s. However, that would not solve the issue because the self-inductance of an air-core coil, which may be approximated by:

L≈μ₀N²s/l, (2)

wherein μ₀ is the free-space magnetic permeability and l is the length of the coil, would increase leading to increased back EMF as well. At first glance, it appears that L can be reduced by simply decreasing N or s.

A solution to this problem of inducing a transient electromagnetic field in an object, is provided by dividing the number of windings of the transmitter coil into two or more groups of windings arranged to cooperatively generate the essentially magnetic dipole field when energized, and to provide switching means arranged to essentially simultaneously terminate the energizing of at least two of the groups of windings. The entire arrangement is such that, at least when the energizing is terminated, the groups of windings are electrically isolated from each other or connected in parallel with each other.

Herewith it is avoided that groups of windings are connected in series with one or more other groups of windings after terminating the energizing. By avoiding that groups of windings are connected in series with one or more other groups of windings after terminating the energizing, the back-EMF voltage is lowered.

This lowers the back-EMF voltage because the total voltage is divided over the groups of coils. Moreover, dividing the coil into groups of windings allows optimization of the geometry such that the mutual induction between the groups is lowered, resulting in an even lower back-EMF voltage altogether.

FIG. 8 schematically shows a transmitter system, wherein the inductive load 4 is provided in the form of two or more energizable inductive segments. In the embodiment of FIG. 8, the inductive load is provided in the form of coil 4 (similar to coil 4 of FIG. 1A), the windings of which have been divided into three groups of windings (unlike the coil 4 of FIG. 1A) to form inductive segments 41, 42, and 43. The groups of windings in the embodiment of FIG. 8 each are connected to a shunt circuit in the form of an optional snubber circuit 61, 62, 63, arranged in parallel connection to the respective groups of windings. The snubber circuit may damp an internal resonance of the group of windings.

In the present example, the windings of the coil 4 have been divided into three equal groups, but this is not a requirement of the invention. The division into groups may be into a different number of groups and/or the groups having mutually different numbers of groups of windings. For instance, in a co-axial arrangement of the groups of windings, a group that is centrally located relative to the other groups may need fewer windings in order to possess the same induction as the other groups.

The segments (groups of windings) 41 to 43 are connected in series with each other. Each segment also comprises a switch 81, 82, 83, in series with the segments.

The groups of windings 41, 42, 43, together with the switches, are series connectable with the power source 2 to energize them. An optional additional switch 81′ is provided as well, in order to enable full isolation of each of the groups of windings from the power supply when energizing is terminated. If such an optional additional switch is provided, one of the switches may function as a primary switch and one as an auxiliary switch as has been detailed hereinabove. Alternatively, any one of switches 81, 82, 83 may be embodied as or replaced by a switching means 9 as shown in FIG. 3 and/or FIG. 4.

The switches 81, 82, 83, and in this embodiment also switch 81′, are controlled by a common controller 11. The common controller 11 may be used to concertedly trigger switching of the switches 81, 82, and 83 into switching into their high-impedance state essentially simultaneously. Optional switch 81′ may also be switched essentially simultaneously but that is not necessary. It may even be desired to purposely delay the switching of one of the switches into its high-impedance state for a certain period of time after switching the other switches.

When the switches are all in their conducting state, more generally stated their low-impedance state, the coil segments are energized by the power supply 2. The coil segments 41, 42, and 43 are arranged to cooperatively generate the essentially magnetic dipole field when energized. In the example, the coil segments are wound coaxially around a common axis A, and the current is directed in the same way such that the magnetic moments add up.

When all switches are open (non- or low conducting state), the groups of windings are electrically isolated from each other and from the power supply 2. The back-EMF voltage spike is thus divided over the coils/switches.

The coil segments 41, 42, 43 need only be electronically separated from each other, not physically. The coil segments 41, 42, 43 may also be wound concentrically one on another, or as multiple helixes interlaced with each other, such as shown in FIG. 9. However, physical separation may be beneficial in that it reduces mutual inductance between the group of windings of the coil.

Generally, when a coil is divided into S segments, such as by dividing the number of windings into S groups of windings, the self-inductance of the total coil is the sum of the self-inductances of each segment and all the mutual cross inductances between the segments.

For instance, the 125-winding coil (corresponding to Table I) may be divided into equal segments 41,42,43. The total coil length remains the same, because the coil segments are abutting to each other. The self-inductance of each segment is approximately one fourth of the value of that of the total coil. The remaining one fourth arises from the mutual cross inductances between the segments. These follow from formulas known to the person of ordinary skill in the art. The ohmic resistance R of each coil segment is simply one third of that of the full 125 winding coil. The distributed capacitance C of each coil segment is more difficult to estimate. It will be assumed to be one third of the full value of Table I. This is not a crucial point, because the segment capacitance may be adjusted by adding a shunt in parallel.

Each segment may further comprise a snubber circuit 61, 62, 63 consisting of a resistor and a capacitor. An overview of the dimensions and parameters are given in Table II in respect of the segments.

TABLE II

| Parameter | value | |
|---|---|---|
| segment diameter | 14 | cm |
| Number of coil segments | 3 | |
| Number of windings per segment | 42 | |
| Pitch of windings | 2 | mm |
| Axial length of each segment | 8.4 | cm |
| Self-inductance in segment | 0.23 | mH |
| Ohmic resistance of segment | 0.15 | Ω |
| Distributed Capacitance segment | 17 | pF |
| Snubber 61 Resistance | 900 | Ω |
| Snubber 62 Resistance | 1000 | Ω |
| Snubber 63 Resistance | 900 | Ω |
| Snubber 61 Capacitance | 2 | μF |
| Snubber 62 Capacitance | 2 | μF |
| Snubber 63 Capacitance | 2 | μF |
| Cross inductance segments 41-42 | 0.060 | mH |
| Cross inductance segments 42-43 | 0.060 | mH |
| Cross inductance segments 41-43 | 0.012 | mH |
| Effective inductance segment 41 | 0.30 | mH |
| Effective inductance segment 42 | 0.35 | mH |
| Effective inductance segment 43 | 0.30 | mH |

The effective inductances of each segment, being the self-inductance of the segment plus the mutual cross inductances arising from the other segments, have been calculated assuming that the currents in the segments are equal to each other. Thus, the voltage across each segment is the sum of the EMF plus R·I_{c}(t), whereby the EMF may be expressed as the effective self-inductance times the time derivative dI_{c}/dt of the current I_{c}(t) in the coil segment.

Since the total coil is essentially equal to the one of Table I, the same current passing through it energizes the magnet to the same magnetic moment as the undivided coil. By dividing the large coil into even more and smaller segments, the voltage across each segment, and therefore each switch, will be reduced. An example employing gated transistor switches for controlling a coil divided into five segments will now be discussed.

FIG. 10 shows a schematic model of a transmitter system comprising a power supply 2 and 5 inductive segments (41 to 45), switches (181 to 185) in the form of IGBTs associated with each of the inductive segments and functioning as primary switches, and an additional auxiliary switch 180 to enable full isolation of all the inductive segments from the power supply 2 including segment 41. Here, the auxiliary switch has been depicted as an IGBT, but it could take the form of another type of switch and particularly another type of gated transistor.

FIG. 10 further shows gate drivers 90 to 95 to control the voltages of the gates of the IGBT switches 180 to 185, and potential limiting circuits 24 between the gate terminals with the respective emitter terminals of the switches. The gate voltage of the IGBT must be controlled relative to the emitter voltage, and therefore the gate drivers are connected to their respective emitters via lines 50, 51, 52, 53, 54, 55, respectively, to act as “floating ground”. The gate drivers may also comprise a voltage source relative to the floating ground to power the IGBT gate drivers 91 to 95.

The switches 181 to 185, in the present embodiment, are mutually coupled via timing line 7, to allow essentially simultaneous switching of all the switches. The timing may be managed employing a microcontroller 11. The timing of the auxiliary switch 180, delayed relative to the timing of the primary switches, is also managed by microcontroller 11 but via line 7′.

Alternatively, switches 180 to 184 may function as primary switches while the switch 185 that is closest to the power supply ground may function as the auxiliary switch. In that case, the timing circuitry must be adapted mutatis mutandis.

A first power supply 2 provides power to the coil segments 41 to 45; a second power supply 13 provides power to the microcontroller 11. Microcontroller 11 may be provided in any suitable form, including an analogue circuit, a microprocessor, a programmable microcontroller, a programmable interface controller (PIC), a digital signal processor (DSP).

The emitter of the IGBT 180 is connected to the same ground as power supply 2, but the emitter potentials at the IGBTs 181 to 185 may be subject to high back-EMF voltages imposed by the coil segments 41 to 45. In order to avoid these voltages to be connected to microcontroller 11, opto-coupling techniques may be employed as has been set forth with more particularity hereinabove with reference to FIG. 6.

The coil segments 41 to 45 in the embodiment as depicted in FIG. 10 are axially separated from each other, providing room for the electronic components and to reduce the mutual cross inductances between the segments.

The transmitter system of FIG. 10 may operate as follows. The microcontroller 11 provides a primary timing signal on line 7 and a secondary timing signal on line 7′ delayed relative to the primary timing signal. Alternatively, individual timing signals could be provided on individual lines leading to each driver 90-95. The timing signals are initially at ground, forcing the IGBTs 180 to 185 into their high-impedance state. No current is then flowing through any of the coil segments 41 to 45.

The microcontroller 11 then transitions the primary timing signal on line 7 from ground to a high-level, e.g. 5 V, preferably faster than the IGBT switching time, e.g. in less than about 100 ns. The timing signal is fed to the drivers 91 to 95, which react by supplying a drive voltage to the IGBT gates relative to the emitter voltage. The drive voltage is sufficiently high, typically higher than about 20 V, to bring the IGBTs 180 to 185 into a low-impedence state. The coil segments 41 to 45 begin to be energized as a result of current flowing through them. After about 15 ms, a steady state has been reached, and the timing signal transitions back to ground, causing the drivers 90 to 95 to reduce the drive voltage and the IGBTs 180 to 185 to return to their high-impedance state. The current in the segments 41 to 45 is then dissipated, assisted by the snubber circuits 61 to 65, until each coil segment 41 to 45 is switched off. A time-resolved transient electromagnetic signal may be recorded during the time that the IGBTs are in their high-resistance state.

This procedure may be repeated over and over again if desired.

The dimensions and properties of the embodiment of FIG. 10 may be as provided in Table III below:

TABLE III

| Parameter | value | |
|---|---|---|
| segment diameter | 14 | cm |
| Number of coil segments | 5 | |
| Number of windings per segment | 20 | |
| Pitch of windings | 2 | mm |
| Axial length of each segment | 4.0 | cm |
| Separation between segments | 5.0 | cm |
| Self-inductance in segment | 0.076 | mH |
| Ohmic resistance of segment | 0.072 | Ω |
| Distributed Capacitance segment | 5 | pF |
| Snubber Resistance all snubbers | 300 | Ω |
| Snubber Capacitance all snubbers | 4.7 | μF |
| Cross ind. adjacent segments | 9.3 | μH |
| Cross ind. segm. spaced 1 apart | 2.1 | μH |
| Cross ind. segm. spaced 2 apart | 0.75 | μH |
| Cross ind. segm. spaced 3 apart | 0.33 | μH |

The self-inductance and the distributed capacitance in the segments have been estimated, and the mutual cross inductances have been calculated.

The antenna segments (typically inductive segments) are not required to be connected in series, at least not when being energized. There are other classes of embodiments as will be set forth with reference to FIGS. 11 to 13.

FIG. 11 shows a transmitter system that is representative of a class of other embodiments, wherein the segments each comprise a dedicated power supply indicated at 21; 22; 23, respectively. Three axially aligned segments have been depicted, but any number of segments may be employed. Switch means (81; 82; 83), each of which may comprise a primary and an auxiliary switch, have been arranged in series with each segment in order to enable disconnecting the coils 41/42/43 and snubbers 61/62/63 from the power supplies 21/22/23. Also shown is common controller 11.

The operation of this class of embodiments is similar to the other embodiments. One difference is that, in this embodiment the coil segments are electrically isolated from each other not only when the energizing is terminated, but also during the energizing (except for common grounding).

In this class of embodiments, each of the switch means may connect a group of windings to a common ground, which makes it relatively easy to reference a gate voltage for the switches to ground.

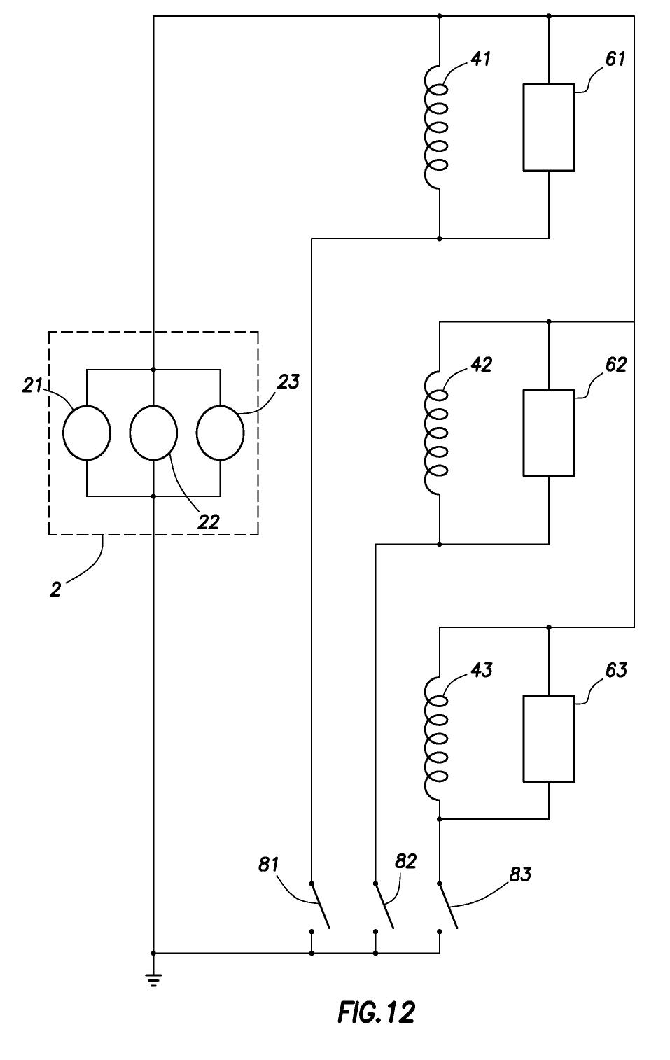

Alternatively, any number of the segments of FIG. 11 may be connected in parallel to each other, and share a single power supply 2 as is illustrated in FIG. 12. However, that would require the power supply to generate a current corresponding to the sum of the required or desired currents through each of the parallel coil segments (41,42,43), which may in practice be less attractive. The increased current requirement of the power supply 2 has been schematically depicted in FIG. 12 by showing three parallel power supplies 21, 22, 23 internal to the power supply 2.

The switch means 81, 82, 83 may all be advantageously referenced to a common ground.

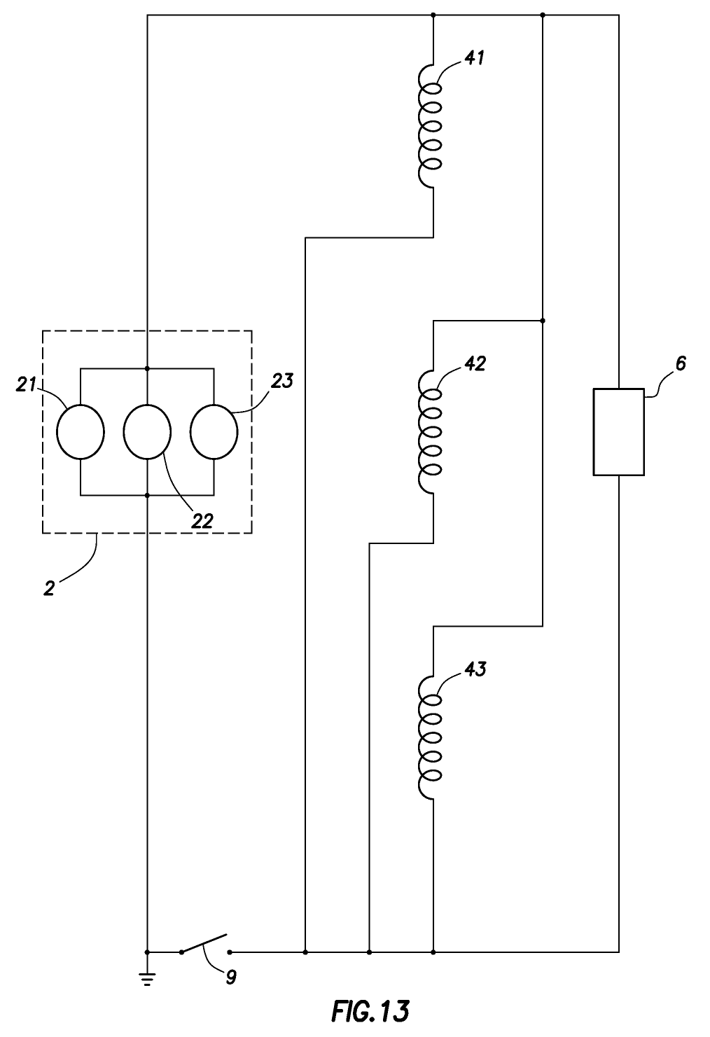

Since the current of several coil segments is collected, embodiments with parallel arranged coil segments also allow for a single switch 8 to terminate the energizing of all of the coil segments that are connected in parallel, as schematically depicted in FIG. 13. Of course, the switch means 9, which may comprise primary and auxiliary switches, is preferably selected partly based on its ability to pass and switch high currents. Some IGBTs are specified at 70 A, which would practically allow approximately 3 parallel coil segments in a down hole tool for transient electromagnetic logging purposes. An optional snubber circuit depicted at 6 may be provided parallel to the coil segments, to damp coil induced resonances and oscillations. Since all the coil segments remain in parallel connection even after terminating the energizing, a single optional snubber circuit 6 shunting all coil segments could suffice.

The embodiments of FIGS. 12 and 13 may be combined. In such a combination, the switch means 81, 82, 83 (each dedicated to a group of windings) could then for instance function as primary switches and the common switch 9 could then function as an auxiliary switch in accordance with the principles set forth hereinabove, or vice versa.

Other combinations of the classes of embodiments in a single transmitter system are also contemplated.

A suitable IGBT for use as a primary switch in the present transmitter systems and applications is one from the so-called IXGH12N100-series (e.g. IXGK35N120BD1), which has a specified 1000 V breakdown at temperatures up to 150° C. Other IGBTs may have similar, better, or other acceptable specifications. A suitable gate driver may incorporate one from the IXDD409-series, or alternatively one of IXDD408, IXIXDD408, IXDI409, IXDN409, IXDD414.

However, alternative gate transistors exist that may be used, either for primary switch as for auxiliary switch. Generally, many types of field effect transistors (FET) are suitable. Typically, a MOSFET may be a faster type of gate transistor than an IGBT, but generally have lower breakdown voltage, on the order of a few hundred Volts, typically about 200 V, and/or a relatively high internal resistance which may cause a problem when energizing the antenna segments with high current.

As will be explained in more detail now, the voltage spike may be further reduced by different adaptations of the snubber circuit shunting the coil segments. This may enhance both the turn-off time of the transmitter system and the signal-to-noise ratio. For instance, the attenuation of the current in the above cases was found to be (nearly) exponential. This results in a relatively high peak voltage as at early times the time derivative of the current is relatively high. Ideally, the attenuation of the current is linear in time, and consequently a snubber circuit is preferably arranged to impose a linear attenuation of the current.

This may be achieved by a different design of the snubber circuit. For instance, the snubber circuit may comprise an active element, for instance, a transistor, a diode, a Zener diode, an avalanche diode, or a varistor.

FIG. 14 shows an example of such a snubber circuit, comprising a Zener diode Z connected in parallel to a capacitor C and resistor R.

Referring, again, to FIG. 7, the transmitter and receiver antennae are brought in the earth formation via wellbore 39 as part of a LWD sub supported by a drill string.

An electromagnetic signal may be transmitted from the transmitter antenna 35 (and/or optional antenna segments 35′) and an electromagnetic induction signal may be created in the form of a response signal such as a voltage response or a current response in the receiver antenna 36.

The response signal may be further processed to locate the mineral hydrocarbon fluid and/or other resistivity anomalies in the earth formation. Details of possible processing are described in US patent application publications 2005/0092487, 2005/0093546, 2005/078481, and 2006/0038571, and in U.S. Pat. No. 5,955,884, already incorporated by reference.

The further processed information may be employed for geosteering purposes. Geosteering may be accomplished by obtaining the transient electromagnetic responses while drilling, and processing the transient responses to locate, for instance, a mineral hydrocarbon fluid reservoir in the earth formation. Geosteering decisions may be made, based on locating any type of electromagnetic anomaly using transient electromagnetic responses. The processed transient electromagnetic induction data may be used to decide where to drill the well bore and/or what is its preferred path or trajectory. For instance, one may want to stay clear from faults. Instead of that, or in addition to that, it may be desirable to deviate from true vertical drilling and/or to steer into the reservoir at the correct depth.

The present invention allows to more accurately locate hydrocarbon fluid containing reservoirs, preferably within a range of between several meters and several hundreds of meters, for instance from about 5 m to 250 m, or for instance from about 5 m to about 100 m. The locality information may advantageously be used to more accurately drill into such reservoirs allowing to produce hydrocarbon fluids from the reservoirs with a minimum of water.

Typically, a shorter depth of investigation requires a faster turn-off time and a lower magnetic moment. A preferred range of magnetic moments generated by the transmitter system is between 5 A·m² and 200 A·m², which has been found to strike a good balance between transient signal strength and turn-off time for geo-steering purposes. Another useful parameter is the product of the transmitted magnetic moment and the effective area (i.e. the aggregate enclosed area by all the windings in the receiver coil added together) of the receiver. In down-hole environment, this product is practicably between 0.1 A·m⁴ and 5000 A·m⁴.

In order to produce the mineral hydrocarbon fluid from an earth formation, a well bore may be drilled with a method comprising the steps of:

suspending a drill string in the earth formation, the drill string comprising at least a drill bit and measurement sub comprising a transmitter antenna and a receiver antenna;

drilling a well bore in the earth formation;

inducing an electromagnetic field in the earth formation employing the transmitter antenna;

detecting a transient electromagnetic response from the electromagnetic field, employing the receiver antenna;

deriving a geosteering cue from the electromagnetic response.

Drilling of the well bore may then be continued in accordance with the geosteering cue until a reservoir containing the hydrocarbon fluid is reached.

Once the well bore extends into the reservoir containing the mineral hydrocarbon fluid, the well bore may be completed in any conventional way and the mineral hydrocarbon fluid may be produced via the well bore.

Geosteering may be based on locating an electromagnetic anomaly in the earth formation by obtaining transient electromagnetic response from the formation, analysing the transient response, and taking a drilling decision based on the location. To facilitate executing the drilling decision, the drill string may comprise a steerable drilling system. The drilling decision may comprise controlling the direction of drilling, e.g. by utilizing the steering system if provided, and/or establishing the remaining distance to be drilled. The steerable drilling system may be of conventional type, including rotatable steering systems and sliding mode steering systems.

Accordingly, the geosteering cue may comprise information reflecting distance between the target ahead of the bit and the bit, and/or direction from the bit to target. Distance and direction from the bit to the target may be calculated from the distance and direction from the tool to the bit, provided that the bit has a known location relative to the electromagnetic measurement tool.

Transient electromagnetic induction data may be correlated with the presence of a mineral hydrocarbon fluid containing reservoir, either directly by establishing conductivity values for the reservoir or indirectly by establishing quantitative information on formation layers that typically surround a mineral hydrocarbon fluid containing reservoir. The hydrocarbon content of a reservoir may be quantified from the transient electromagnetic measurements using known resistivity relationships such as Archie's law.

The present invention has been described in relation to particular embodiments, which are intended in all respects to be illustrative rather than restrictive. Alternative embodiments will become apparent to those skilled in the art to which the present invention pertains without departing from its scope. In particular, it is contemplated that while embodiments described above show a primary and an auxiliary switch, this is not intended to exclude adding additional auxiliary switches as needed or desired. Likewise, it is not intended to exclude embodiments having additional primary switches.

The proposed methods allow switching an as high-strength as possible electromagnetic field to a much lower field strength in an as short a time as possible, which facilitates locating a mineral hydrocarbon fluid reservoir in an earth formation.

It will be understood that certain features and sub-combinations are of utility and may be employed without reference to other features and sub-combinations specifically set forth. This is contemplated and within the scope of the claims.

1. A transmitter system for inducing a transient electromagnetic field in an earth formation, comprising
an inductive element to generate an electromagnetic field in response to a flow of electric current through the inductive element;
switching means arranged to interrupt the flow of electric current through the inductive element, which switching means comprises a primary switch and an auxiliary switch arranged in series connection with each other.

2. The transmitter system of claim 1 wherein the auxiliary switch has a lower breakdown voltage than the primary switch.

3. The transmitter system of claim 1 wherein the auxiliary switch has a lower leakage current than the primary switch, when compared while the primary and auxiliary switches are in their high-impedance states.

4. The transmitter system of claim 1 further comprising delay circuitry to impose a time delay between switching of the auxiliary switch relative to switching of the primary switch.

5. The transmitter system of claim 4, wherein the time delay is long enough for back-EMF voltage generated in the inductive element after switching of the primary switch to fall to a level below a predetermined value.

6. The transmitter system of claim 5, wherein the predetermined value is lower than a break-down voltage of the auxiliary switch.

7. The transmitter system of claim 1 whereby the switching means has at least two specified electrical characteristics, one of which is attributable to a corresponding electrical characteristic of the primary switch and the other one of which is attributable to a corresponding characteristic in the auxiliary switch.

8. The transmitter system of claim 1 wherein at least one of the primary switch and the auxiliary switch comprises a gate transistor comprising first and second terminals connected with each other via a gated channel, and a gate terminal, the system further comprising a potential limiting circuit arranged to limit a potential difference between the gate terminal and one of the first and second terminals.

9. The transmitter system of claim 1 wherein the primary switch is capable of breaking a higher current than the auxiliary switch is capable of breaking.

10. The transmitter system of claim 1 further comprising feedback and control means arranged to control the switching of the auxiliary switch in response to a signal representing actual back-EMF voltage generated in the inductive element at times after switching of the primary switch.

11. The transmitter system of claim 1 wherein the switching means comprises at least one protection circuit that is connected in parallel with the primary switch and/or the auxiliary switch.

12. The transmitter system of claim 1 incorporated in a down-hole tool.

13. A method of inducing a transient electromagnetic field in an earth formation, comprising the steps of
providing, in a vicinity of the earth formation, inductive element to generate an electromagnetic field;
allowing an electric current to flow from a power supply through a primary switch, an auxiliary switch that is arranged in series with the primary switch and has a lower breakdown voltage than the primary switch, and the inductive element;
terminating the electric current from flowing through the inductive element by opening the primary switch and opening the auxiliary switch.

14. A method of obtaining a transient electromagnetic response signal from an earth formation, comprising the steps of:
providing a receiver antenna in the earth formation;
providing, in the earth formation, a transmitter antenna comprising an inductive element to generate an electromagnetic field, a primary switch, and an auxiliary switch having a lower breakdown voltage than the primary switch;
allowing an electric current to flow from a power supply through the primary switch, the auxiliary switch, and the inductive element;
terminating the electric current from flowing through the inductive element by opening the primary switch and opening the auxiliary switch; and
receiving a transient response signal following the terminating of the electric current, employing the receiver antenna.

15. A method of producing a mineral hydrocarbon fluid from an earth formation, the method comprising steps of:
drilling a well bore in the earth formation;
providing, in the earth formation, a transmitter antenna comprising an inductive element to generate an electromagnetic field, a primary switch, and an auxiliary switch having a lower breakdown voltage than the primary switch;
allowing an electric current to flow from a power supply through the primary switch, the auxiliary switch, and the inductive element;
terminating the electric current from flowing through the inductive element by opening the primary switch and opening the auxiliary switch; and
receiving a transient response signal following the terminating;
further processing the transient response signal to locate the mineral hydrocarbon fluid in the earth formation;
continuing drilling the well bore to the hydrocarbon fluid; and
producing the hydrocarbon fluid.
